(19) United States
(12) Patent Application Publication
(10) Pub. No.: US 2004/0141600 A1
(43) Pub. Date: Jul. 22, 2004

(54) Method and apparatus to urgently receive data via facsimile

(75) Inventor: Dong-yul Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/755,281

(22) Filed: Jan. 13, 2004

(30) Foreign Application Priority Data
Jan. 14, 2003 (KR) 2003-2380

(51) Int. Cl. H04M 11/00

(52) U.S. Cl. 379/100.01; 379/100.06

(57) ABSTRACT

A method and apparatus to urgently receive data via a facsimile where the method, which is performed by the facsimile, includes determining whether during communication with a first party, an urgent transmission of data is demanded by a second party; and interrupting communication with the first party and receiving the urgent data from the second party upon determining that the urgent transmission of data is requested from the second party. Therefore, according to the method and apparatus to urgently receive data via facsimile, when an urgent transmission of a message is demanded by a predetermined party in the midst of communication with a different party, it is possible to interrupt the in-progress communication and receive the urgent message. Further, it is possible to urgently receive the message from the predetermined party in an environment designated by the user, such as, during the data transmission and/or receipt to/from the facsimile.

### CROSS-REFERENCE TO RELATED APPLICATIONS

This application claims the priority of Korean Patent Application No. 2003-2380, filed Jan. 14, 2003, in the Korean Intellectual Property Office, the disclosure of which is incorporated herein in its entirety by reference.

### BACKGROUND OF THE INVENTION

1. Field of the Invention

The present invention relates to transmission of data via facsimile, and more particularly, to a method and apparatus to urgently receive data via facsimile.

2. Description of the Related Art

According to a conventional data receiving method performed via facsimile machines, when a third party needs to communicate with a first user via facsimile while the first user is communicating with a second user via facsimile, that is, while the first user is receiving/transmitting a message from/to the second party via facsimile, the conventional data receiving method receives call information including the call number of the third party currently trying to communicate with the first user via facsimile from an exchange connected to a network, and displays the received call information to inform the first user who is in the middle of communicating with the second user or databases, and stores the call information in a separate memory (not shown). The first user can manipulate certain apparatuses such as a key manipulator (not shown) to view a list that contains the call information of the third party. The first user can later select desired persons among the third parities listed in the call information list, who tried to reach the first user when the first user was communicating with the second user, and receive the messages transmitted from the desired persons.

As a result, the conventional data receiving method described above only allows receipt of information in relation to the third party requiring urgent access while the first user is communicating with the second user, but cannot interrupt the on going communication, and thus, cannot receive the actual message (or data) sent from the third party. Therefore, the conventional data receiving method presents a problem in that the user cannot receive an urgent message transmitted from a desired third party while in the midst of communicating with another party.

### SUMMARY OF THE INVENTION

An aspect of the present invention provides a method to urgently receive data via facsimile, which allows a user to urgently receive facsimile messages (or data) from a predetermined third party during communication with a different party.

An aspect of the present invention also provides an apparatus to urgently receive data via facsimile, which allows a user to urgently receive facsimile messages (or data) from a predetermined third party while communicating with a different party.

According to an aspect of the present invention, the method of urgently receiving data via facsimile comprises: determining whether during communication with a first party, an urgent transmission of data is demanded by a second party previously determined to be capable of urgently receiving the data; and interrupting communication with the first party and receiving the urgent data from the second party upon determining that the second party has demanded an urgent transmission of the data.

Additional aspects and advantages of the invention will be set forth in part in the description which follows and, in part, will be obvious from the description, or may be learned by practice of the invention.

According to another aspect of the present invention, an apparatus to urgently receive data, which is installed to a facsimile machine, is provided. The apparatus comprises: a communication request detector which checks whether during communication with a first party an urgent transmission of data is requested from a second party and outputs the checked result as a first control signal; and a data communication controller which interrupts communication with the first party in response to the first control signal and receives the data from the second party.

### BRIEF DESCRIPTION OF THE DRAWINGS

The above and/or other aspects and advantages of the invention will become apparent, and more readily appreciated from the following description of the preferred embodiments taken in conjunction with accompanying drawings of which:

FIG. 1 is a flow chart to describe a method of urgently receiving data via facsimile according to an aspect of the present invention;

FIG. 2 is a block diagram of an apparatus to urgently receive data to perform the method of urgently receiving data shown in FIG. 1 according to an aspect of the present invention;

FIG. 3 is a flow chart to illustrate operation 10 of FIG. 1 according to an aspect of the present invention;

FIG. 4 is a block diagram of a communication request detector of FIG. 2, according to an aspect of the present invention;

FIG. 5 is a flow chart to illustrate an operation to set at least one urgent phone number and an urgent receipt enable condition according to an aspect of the present invention;

FIG. 6 is a block diagram of an apparatus to perform the operation shown in FIG. 5 according to an aspect of the present invention;

FIG. 7 is a flow chart to illustrate an operation to for update at least one urgent phone number and the urgent receipt enable condition, according to an aspect of the present invention;

FIG. 8 is a block diagram of an apparatus to perform the operation shown in FIG. 7 according to an aspect of the present invention;

FIG. 9 is a block diagram to show an example of a phone number and condition setting unit shown in FIG. 6 or FIG. 8 according to an aspect of the present invention;

FIG. 10 is a block diagram to show another aspect of the phone number and condition setting unit shown in FIG. 6 or FIG. 8 according to the present invention;

FIG. 11 is a block diagram of a data communication controller of FIG. 2;

FIG. 12 is a flow chart to illustrate an operation performed after urgent data from a second party is received according to an aspect of the present invention;

FIG. 13 is a block diagram of an apparatus to perform the method of FIG. 12 according to an aspect of the present invention;

FIG. 14 is a flow chart to illustrate operation 132 of the method of FIG. 12 according to an aspect of the present invention;

FIG. 15 is a block diagram to show an aspect of a communication restart unit to perform the operation of FIG. 14 according to the present invention;

FIG. 16 is a flow chart to illustrate another aspect of operation 132 in the method of FIG. 12, according to the present invention; and

FIG. 17 is a block diagram to show another aspect of the communication restart unit to perform the operation of FIG. 16, according to another aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

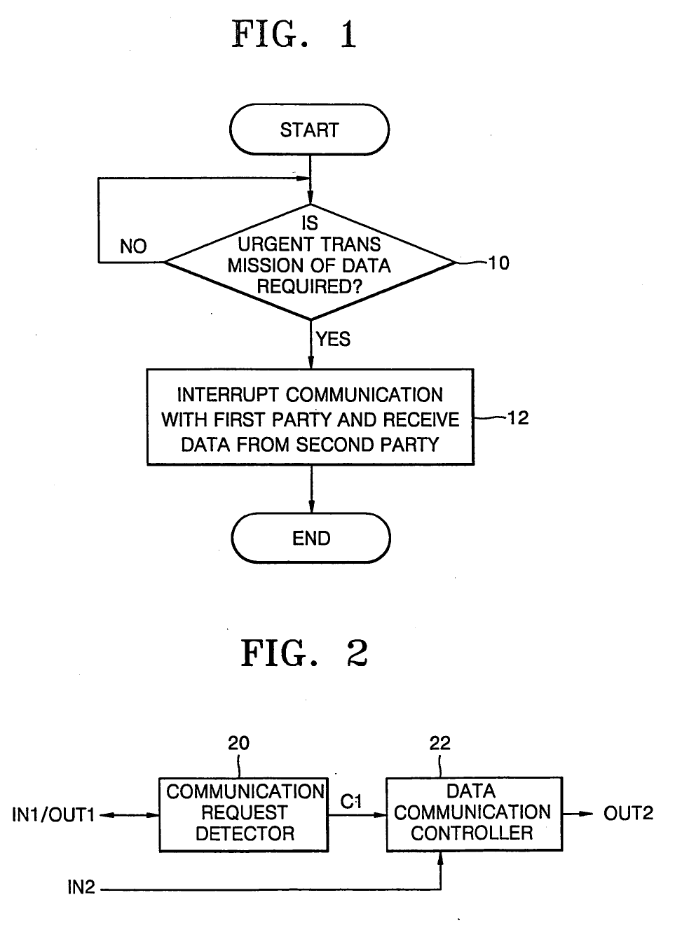

FIG. 1 is a flow chart to describe a method to urgently receive data via facsimile according to an aspect of the present invention, wherein the method comprises operations 10 and 12 to urgently receive data from a third party while the recipient is communicating with a different party.

FIG. 2 is a block diagram of an apparatus to urgently receive data to perform the method to urgently receive data shown in FIG. 1 according to an aspect of the present invention, wherein the apparatus to urgently receive data comprises: a communication request detector 20 and a data communication controller 22.

The method to urgently receive data according to an aspect of the present invention is performed via a facsimile machine. Accordingly, the apparatus to urgently receive data shown in FIG. 2 can be provided to the facsimile machine.

Referring to FIGS. 1 and 2, the method and apparatus to urgently receive data according to an aspect of the present invention is described in the following paragraphs.

In operation 10 of FIG. 1, it is determined whether an urgent receipt of data transmitted from a third party (hereinafter, referred to as a second party previously determined to be capable of urgently receiving the data) is required while a user of a facsimile is communicating with a different party (hereinafter, referred to as a first party). Accordingly, while the communication request detector 20 receives and transmits data from/to the first party through output terminal OUT1 and input terminal IN1, the request detector 20 checks whether the urgent transmission of data is required from the second party previously determined to be capable of urgently receiving the data and outputs the checked result as a first control signal C1 to the data communication controller 22.

Hereinafter, operation 10 of FIG. 1 and the communication request detector 20 of FIG. 2 according to an aspect of the present invention will be described in detail.

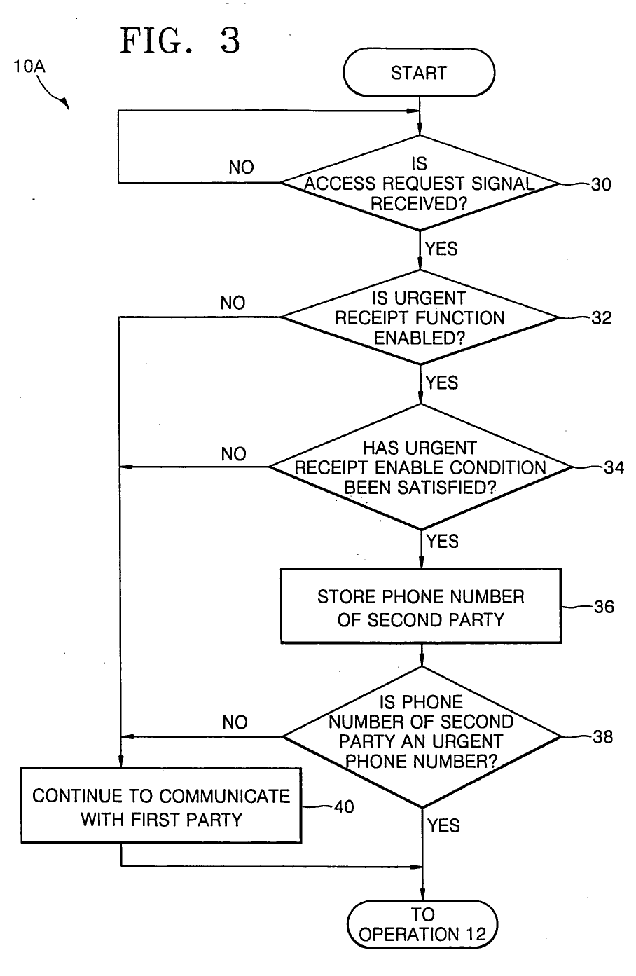

FIG. 3 is a flow chart to describe an aspect of the invention 10A to perform operation 10 of FIG. 1, wherein when a communication request is generated from the second party, it is determined whether data transmitted from the second party should be urgently received.

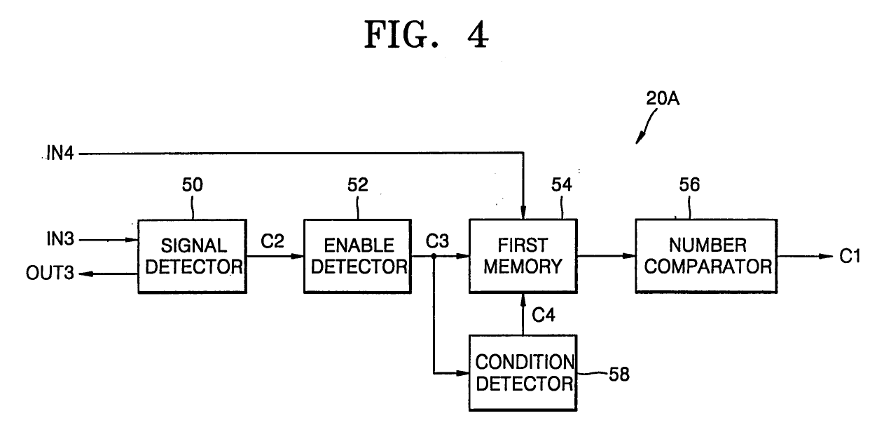

FIG. 4 is a block diagram to show the communication request detector 20 shown in FIG. 2 according to an aspect of the present invention, wherein the communication request detector 20A comprises a signal detector 50, an enable detector 52, a first memory 54, a number comparator 56, and a condition detector 58.

As shown in FIG. 3, according to operation 10, it is determined whether an access request signal requiring access to the user is received from the second party during communication with the first party (operation 30). Accordingly, the signal detector 50 (shown in FIG. 4) checks whether the access request signal requiring access to the user is received from the second party via input terminal IN3 while receiving and transmitting data from/to the first party via input terminal IN3 and output terminal OUT3 of the signal detector 50, and outputs the checked result as a second control signal C2 to the enable detector 52. The access request signal may be a call waiting signal, which can be provided from an exchange (not shown).

Upon receipt of the access request signal from the second party, it is determined whether an urgent receiving function is enabled (operation 32). The urgent receiving function is a function that interrupts communication with a first party and receives urgent data from a predetermined second party when an urgent transmission of data is demanded by the predetermined second party during communication with the first party.

In operation 32, the enable detector 52 (shown in FIG. 4) determines whether the urgent receiving function is enabled in response to the second control signal C2 received from the signal detector 50, and outputs the determined result as a third control signal C3 to the first memory 54 and the condition detector 58. If the second control signal C2 signals that the access request signal is received from the second party, the enable detector 52 can check whether the urgent receiving function is enabled. For example, the enable detector 52 may be an enable button (not shown), which may be pressed by a user who desires to enable the urgent receiving function. If the enable button is pressed, the third control signal C3 is output to indicate that the urgent receiving function is enabled, from the enable button in response to the second control signal C2.

Upon determining that the urgent receiving function is enabled, it is determined whether an urgent receipt enable condition predetermined by the user is satisfied (operation 34). Accordingly, the condition detector 58 (shown in FIG. 4) checks whether the urgent receipt enable condition is satisfied in response to the third control signal C3 received from the enable detector 52, and outputs the checked result as a fourth control signal C4 to the first memory 54. That is, if the third control signal C3 signals that the urgent receiving function is enabled, the condition detector 58 checks whether the urgent receipt enable condition is satisfied.

According to an aspect of the present invention, the urgent receipt enable condition is a case where when a facsimile is being transmitted to a first party, a second party requires urgent transmission of data via facsimile. As described above, if the condition detector 58 recognizes, via the third control signal C3, that the urgent receiving function is enabled, it checks whether such urgent receipt enable condition is satisfied, that is, whether the second party demands the urgent transmission of data while data is being transmitted to the first party. At this time, the data transmitted to the first party may be stored.

According to another aspect of the present invention, the urgent receipt enable condition occurs when facsimile data is received from a first party, and a second party demands urgent transmission of data to the facsimile. As described above, if the condition detector 58 recognizes via the third control signal C3 that the urgent receiving function is enabled, it checks whether such urgent receipt enable condition is satisfied, that is, whether the second party demands the urgent transmission of data while data is being received from the first party.

According to an aspect of the present invention, the urgent receipt enable condition occurs when a user of a facsimile is establishing a call connection with a first party, and a second party demands urgent transmission of data to the facsimile. As described above, if the condition detector 58 recognizes, via the third control signal C3, that the urgent receiving function is enabled, it checks whether such urgent receipt enable condition is satisfied, that is, whether the second party demands the urgent transmission of data while the user is establishing a call connection with the first party.

According to an aspect of the present invention, the urgent receipt enable condition occurs when a facsimile is receiving/transmitting data from/to a first party and a second party demands urgent transmission of data via facsimile. As described above, if the condition detector 58 recognizes, via the third control signal C3, that the urgent receiving function is enabled, it checks whether such urgent receipt enable condition is satisfied, that is, whether the second party demands the urgent transmission of data while the data is being received/transmitted from/to the first party.

Thus, the urgent receiving method of FIG. 1 can be set by the user so that the data urgent receipt from a second party is processed while the facsimile is transmitting data to the first party, while facsimile data is being received from the first party, or while facsimile data is being received/transmitted from/to the first party.

If the urgent receipt enable condition is satisfied, the phone number of the second party is stored (operation 36). Accordingly, the first memory 54 stores the phone number of the second party input through input terminal IN4 of the first memory 54 in response to the fourth control signal C4 received from the condition detector 58. That is, if the fourth control signal C4 signals that the urgent receipt enable condition is satisfied, the first memory 54 can store the phone address of the second party.

However, operation 34 of 10A shown in FIG. 3 may be omitted. In this case, if the access request signal is received and the urgent receiving function is enabled regardless of the state of the facsimile, the phone address of the second party is stored. If it is signaled by the third control signal C3 received from the enable detector 52 that the urgent receiving function is enabled, the first memory 54 stores the phone address of the second party input through its input terminal IN4. Here, the phone number of the second party is generated from a caller ID decoder (not shown). The caller ID decoder acts to extract the phone number of the second party.

After storing the phone number of the second party, it is determined whether the stored phone number of the second party is an urgent phone number (operation 38). The urgent phone number is a phone number from which the user of the facsimile allows urgent receipt of facsimile data during communication with a different party. The urgent phone number can be preset by the user of the facsimile. Then, the number comparator 56 checks whether the phone number of the second party stored in the first memory 54 is an urgent phone number, and outputs the checked result as a first control signal C1 to the data communication controller 22.

Hereinafter, operation to set and/or update at least one of the urgent phone numbers or the urgent receipt enable condition according to an aspect of the present invention will be described.

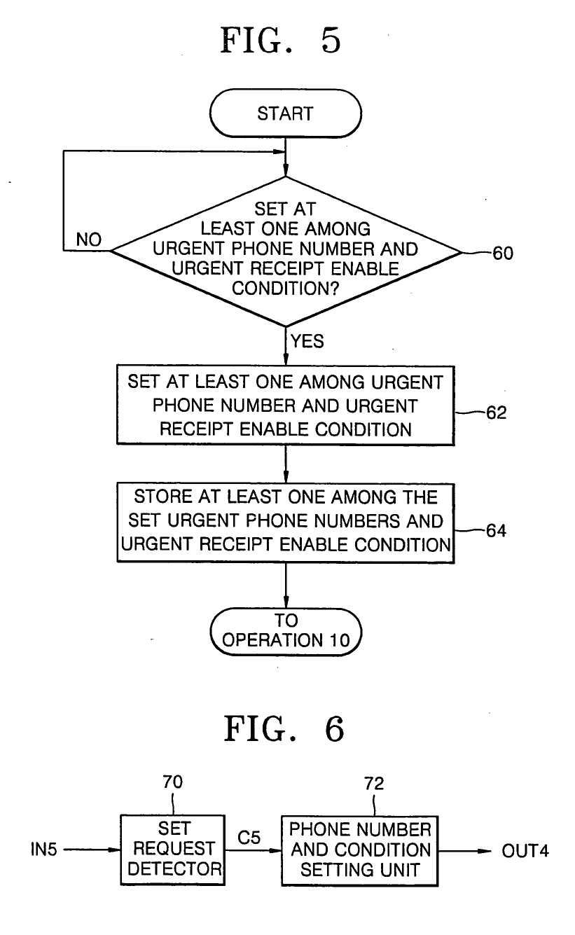

FIG. 5 is a flow chart to illustrate an operation to set at least one of the urgent phone numbers and urgent receipt enable condition according to an aspect of the present invention, which comprises operation 60 through 64 to set and store at least one among the urgent phone numbers and urgent receipt enable condition.

FIG. 6 is a block diagram of an apparatus to perform the operation of FIG. 5, wherein the apparatus comprises a set request detector 70 and a phone number and condition setting unit 72.

Referring to FIGS. 5 and 6, first, it is determined whether to set at least one among the urgent phone numbers and the urgent receipt enable condition is requested by the user (operation 60). Accordingly, the set request detector 70 checks whether to set at least one among the urgent phone numbers and the urgent receipt enable condition is requested by the user, and outputs the checked result as a fifth control signal C5 to the phone number and condition setting unit 72. The set request detector 70 generates a fifth control signal C5 in response to a set request signal input through input terminal IN5 of the set request detector 70 from a key manipulator (not shown), wherein the key manipulator is manipulated by the user desiring to set at least one of the urgent phone numbers and the urgent receipt enable condition.

If it is determined that the user requires to set the urgent phone numbers, the urgent phone numbers are set. If it is determined that the user requires to set the urgent receipt enable condition, the urgent receipt enable condition is set (operation 62). The phone number and condition setting unit 72 sets at least one of the urgent phone numbers and the urgent receipt enable condition in response to the fifth control signal C5 received from the set request detector 70, and outputs the set urgent phone numbers and/or the set urgent receipt enable condition through output terminal OUT4 of the phone number and condition setting unit 72. That is, if it is recognized by the fifth control signal C5 that the user requires to set the urgent phone numbers and/or the urgent receipt enable condition, the urgent phone number and condition setting unit 72 sets the urgent phone numbers and/or the urgent receipt enable condition is requested by the user.

Then, after operation 62, the set urgent phone numbers and/or the set urgent receipt enable condition is/are stored (operation 64), and it proceeds to operation 10. For that, the first memory 54 receives the set urgent phone numbers and/or the set urgent receipt enable condition input through its input terminal IN4 from the phone number and condition setting unit 72 and stores them. Accordingly, in the number comparator 56, an urgent phone number which is compared with the phone number of the second party is also read from the first memory 54.

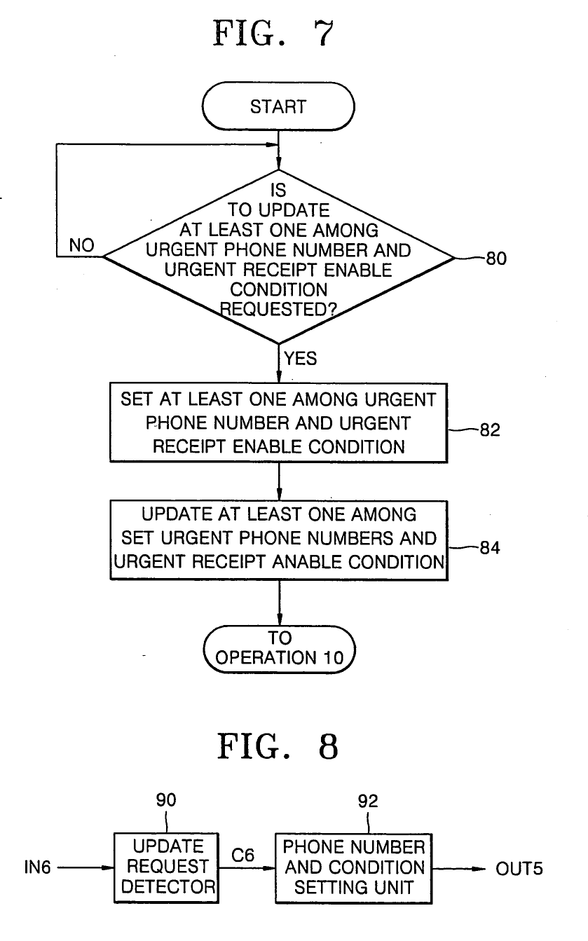

FIG. 7 is a flow chart to illustrate a method to update at least one of the urgent phone numbers and urgent receipt enable condition according to an aspect of the present invention, wherein the method comprises operations 80 through 84, which update at least one of the urgent phone number and urgent receipt enable condition.

FIG. 8 is a block diagram of an apparatus to perform the operation of FIG. 7, wherein the apparatus comprises: an update request detector 90 and a phone number and condition setting unit 92.

As shown in FIGS. 7 and 8, first, it is determined whether to update at least one of the urgent phone numbers or urgent receipt enable condition is requested by the user (operation 80). Accordingly, the update request detector 90 checks whether to update at least one of the urgent phone numbers and urgent receipt enable condition is requested by the user, and outputs the checked result as a sixth control signal C6 to the phone number and condition setting unit 92. The update request detector 90 generates the sixth control signal C6 in response to the update request signal input through input terminal IN6 of the update request detector 90 from the key manipulator (not shown), wherein the key manipulator is manipulated by the user who wants to update at least one among the urgent phone numbers and urgent receipt enable condition.

If the user requests to update at least one of the urgent phone numbers and urgent receipt enable condition, the urgent phone number or urgent receipt enable condition which the user requests to update are set (operation 82). Accordingly, the phone number and condition setting unit 92 sets the urgent phone numbers and/or urgent receipt enable condition, which the user requests to update, in response to the sixth control signal C6 received from the update request detector 90, and outputs the set urgent phone numbers and/or set urgent receipt enable condition through output terminal OUT5 of the phone number and condition setting unit 92. For example, if signaled by the sixth control signal C6 that the user has requested to set the urgent phone numbers or urgent receipt enable condition, the urgent phone numbers and/or urgent receipt enable condition are set (updated) by the user.

After operation 82, the previous urgent telephone number is updated to the set urgent phone number and/or the previous receipt enable condition is updated into the set urgent receipt enable condition, the set urgent phone number and set urgent receipt enable condition are stored, and the method proceeds to operation 10 (operation 84). Accordingly, the first memory 54 updates the previous urgent phone number into the urgent phone number set in the phone number and condition setting unit 92 and stores the updated urgent phone number, and/or updates the previous urgent receipt enable condition into the set urgent receipt enable condition and stores the updated urgent receipt enable condition.

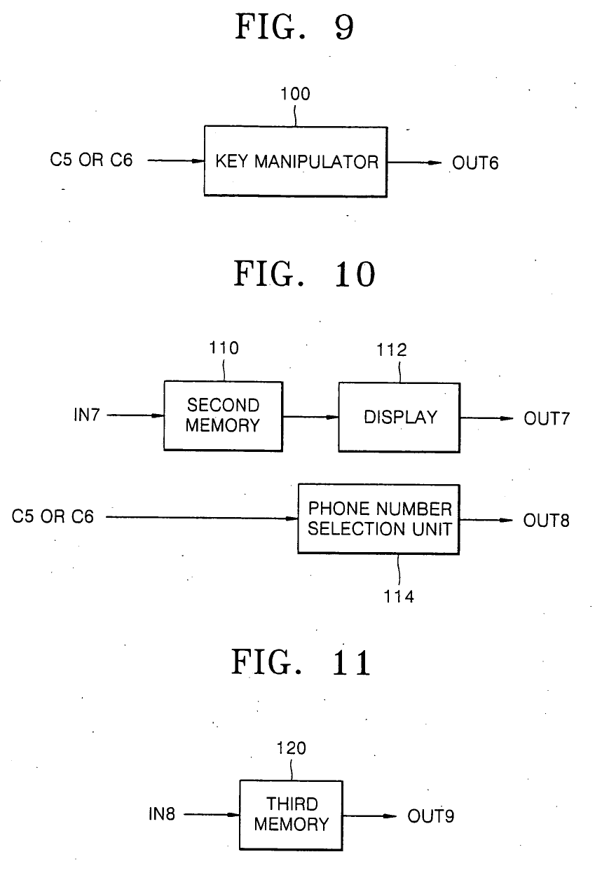

FIG. 9 is a block diagram to show an aspect of the phone number and condition setting unit 72 or 92 shown in FIG. 6 or FIG. 8, wherein the phone number and condition setting unit 72 or 92 is implemented by a key manipulator 100.

The key manipulator 100 is manipulated by the user to set the urgent phone numbers and/or the urgent receipt enable condition. The key manipulator 100 outputs the set urgent phone numbers and/or the urgent receipt enable condition through the output terminal OUT6 in response to the fifth or sixth control signals C5 or C6 received from the set or update request detector 70 or 90. According to an aspect of the present invention, the key manipulator 100 may be a keyboard (not shown).

FIG. 10 is a block diagram to show another aspect of the phone number and condition setting unit 72 or 92 shown in FIG. 6 or FIG. 8, wherein the phone number and condition setting unit comprises a second memory 110, a display 112, and the phone number selection unit 114.

Referring to FIG. 10, the second memory 110 stores a phone number list input through input terminal IN7 of the second memory 110. The phone number list includes phone numbers of the first parties with whom the user of the facsimile often communicates, and for example, may be a caller ID service list.

The display 112 displays the first parties and their phone numbers listed in the phone number list read from the second memory 110 via output terminal OUT7 of the display 112 to the user.

The phone number selection unit 114 designates phone numbers selected by the user from the phone numbers in the phone number list displayed on the display 112 as urgent phone numbers and outputs the designated urgent phone numbers through output terminal OUT8 of the phone number selection unit 114 in response to the fifth or sixth control signal C5 or C6. If it is recognized by the fifth or sixth control signal, C5 or C6, that the setting or update of the urgent phone numbers is required, the phone number selection unit 14 outputs the designated urgent phone numbers via output terminal OUT8.

Again as shown in FIG. 1, when urgent transmission of data is demanded by the second party during communication with the first party, communication with the first party is interrupted and the data from the second party is received (operation 12).

Further, as shown in FIG. 2, to perform operation 12, the data communication controller 22 interrupts communication with the first party in response to the first control signal C1 received from the communication request detector 20, and receives the data transmitted from the second party through input terminal IN2 of the communication controller 22. That is, if it is recognized by the first control signal C1 that urgent transmission of data is demanded by the second party, the data communication controller 22 switches the communication line connected to the first party to the second party to interrupt communication with the first party, and receives the data transmitted from the second party. In the case that operation 10 shown in FIG. 1 is embodied according to the method of FIG. 3, communication with the first party is interrupted and the data transmitted from the second party is received if it is determined that the phone number of the second party is the urgent phone number in operation 38 of FIG. 3.

However, if it is determined that the urgent receiving function is not enabled, the urgent receipt enable condition is not satisfied or the phone number of the second party is not the urgent phone number communication with the first party in progress continues (operation 40).

According to operation 40, if it is recognized that the urgent receiving function is not enabled, the urgent receipt enable condition is not satisfied or the phone address of the second party is not an urgent phone number, in response to the first control signal C1 received from the communication request detector 20, the data communication controller 22 continues communication with the first party through input terminal IN2 and output terminal OUT2 of the data communication controller.

FIG. 11 is a block diagram of the data communication controller 22 of FIG. 2 where the data communication controller 22 includes a third memory 120.

If the data communication controller 22 recognizes that the data from the second party should be urgently received, in response to the control signal C1 received from the communication request detector 20, it stores the data being transmitted to the first party in the third memory 120. The third memory 120 receives the data being transmitted to the first party through input terminal IN8 and stores the data when communication with the first party is interrupted. The stored data is read from the third memory 120 through output terminal OUT9 of the third memory 120.

Hereinafter, a method performed after data urgently transmitted from a second party is received according to an aspect of the present invention will be described in detail.

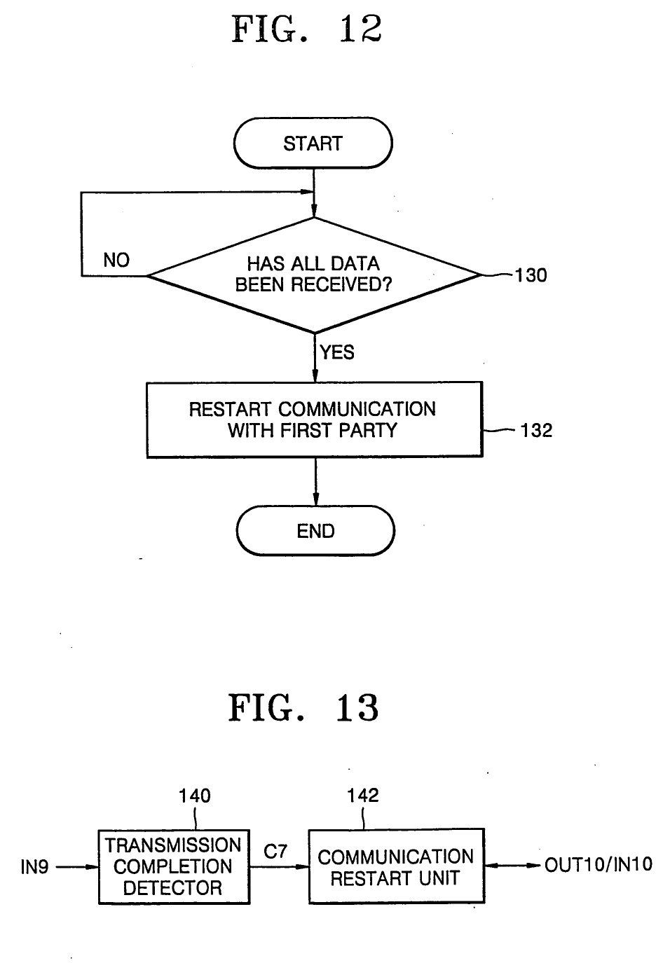

FIG. 12 is a flow chart to describe a method performed after data from a second party is received, according to an aspect of the present invention, where the method is to restart communication with the first party when all data from the second party is received in operations 130 and 132.

FIG. 13 is a block diagram of an apparatus to perform the method of FIG. 12, where the apparatus comprises a transmission completion detector 140 and a communication restart unit 142.

After operation 12, it is determined whether all data from the second party is received (operation 130). Accordingly, the transmission completion detector 140 checks whether all data from the second party is received, and outputs the checked result as a seventh control signal C7 to the communication restart unit 142. More specifically, the data communication controller 22 checks whether all data urgently transmitted from the second party through the input terminal IN2 is received, and outputs the checked result as a transmission completion signal to the transmission completion detector 140 through its output terminal OUT2. At this time, the transmission completion detector 140 generates a seventh control signal C7 in response to the transmission completion signal received through the input terminal IN9 from the data communication controller 22.

When all data from the second party is received, the communication with the first party is restarted (operation 132). Accordingly, the communication restart unit 142 restarts communication with the first party in response to the seventh control signal C7 received from the transmission completion detector 140. That is, if it is recognized by the seventh control signal C7 that all data from the second party is received, the communication restart unit 142 restarts communication with the first party through input terminal IN10 and output terminal OUT10 of the communication restart unit 142.

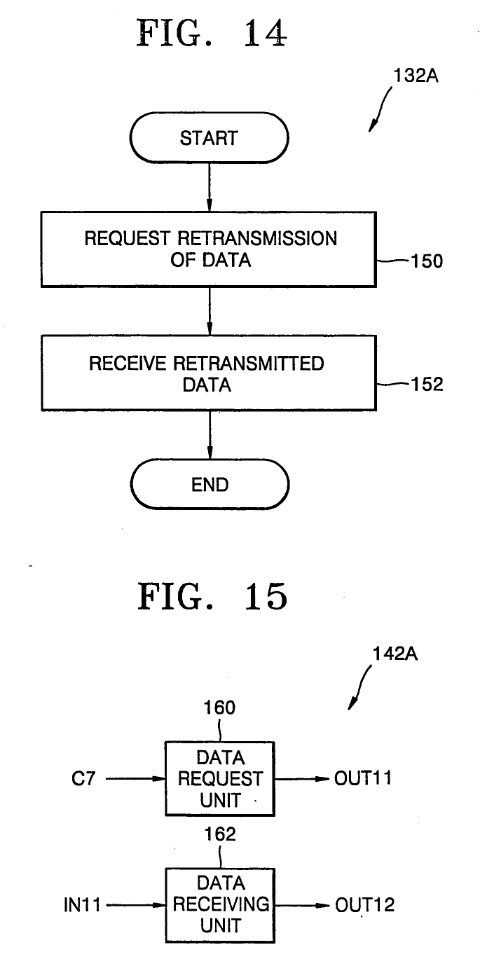

FIG. 14 is a flow chart to illustrate method 132A according to an aspect of the present invention to perform operation 132 in the method of FIG. 12, where method 132A comprises operations 150 and 152 according to which the retransmission of data is requested and data is received.

FIG. 15 is a block diagram to show aspect 142A of the communication restart unit 142 to perform the embodiment 132A of FIG. 14, according to an aspect of the present invention, where the embodiment 142A comprises the data request unit 160 and the data receiving unit 162.

Referring to FIGS. 14 and 15, when all data from the second party is received, data retransmission is required to the first party (operation 150). Accordingly, a data request unit 160 generates a data transmission request signal to request retransmission of data to the first party in response to the seventh control signal C7 received from the transmission completion detector 140, and outputs the generated data transmission request signal through output terminal OUT11 of the data request unit 160. That is, if it is recognized by the seventh control signal C7 that all data from the second party is received, the data request unit 160 generates the data transmission request signal. The first party who receives the data transmission request signal retransmits the previously interrupted data to the user.

Then, after operation 150, data retransmitted from the first party is received (operation 152). For performing operation 152, a data receiving unit 162 receives the retransmitted data from the first party through input terminal IN11 and outputs the received data through output terminal OUT12.

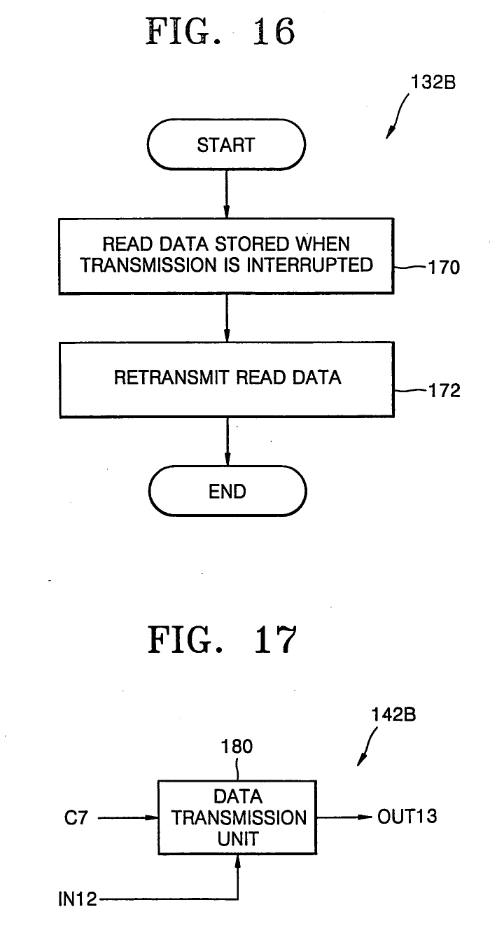

FIG. 16 is a flow chart illustrate an aspect 132B of operation 132 in the method of FIG. 12, according to an aspect of the present invention, where the data is read out and is retransmitted in operations 170 and 172.

FIG. 17 is a block diagram show an aspect 142B of the communication restart unit 142 to perform the embodiment 132B of FIG. 16, according to an aspect of the present invention, where the communication restart unit 142B includes a data transmission unit 180.

Referring to FIGS. 16 and 17, when all data from the second party is received, the data stored when communication with the first party is interrupted is read out (operation 170). After the stored data is read out, the read data is retransmitted to the first party (operation 172).

To perform operation 170, the data transmission unit 180 reads the data stored in the third memory 120 when communication with the first party is interrupted in response to the seventh control signal C7 received from the transmission completion detector 140, and receives the read data through input terminal IN12. In operation 172, the data transmission unit 180 retransmits the data read from the third memory 120 to the first party through output terminal OUT13 of the data transmission unit.

As described above, according to the data urgent receiving method and apparatus in facsimile according to an aspect of the present invention, an effect exists in that when an urgent transmission of a message is demanded by a predetermined party in the midst of communicating with a different party, it is possible to interrupt the communication in progress and receive the urgent message. Also, it is possible to urgently receive the message from the predetermined party in an environment desired by the user, such as during data transmission or receipt to/from the facsimile.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method to urgently receive data via facsimile, comprising:
determining whether an urgent transmission of data is demanded by a second party previously determined to be capable of urgently receiving the data during communication with a first party; and
interrupting communication with the first party and receiving the urgent data from the second party upon determining that the urgent transmission of data is required from the second party during communication with the first party.

2. The method according to claim 1, wherein the determination of whether an urgent transmission of data is demanded by the second party comprises:
determining whether an access request signal is received from the second party during communication with the first party;
determining whether an urgent receipt function is enabled upon determining that the access request signal is received from the second party;
storing a phone number of the second party upon determining that the urgent receiving function is enabled;
determining whether the phone number of the second party is among urgent phone numbers from which the user allows urgent receipt of data; and
interrupting communication held with the first party and receiving the urgent data from the second party, upon determining that urgent transmission of data is requested from the second party and the phone number of the second party is among the urgent numbers.

3. The method according to claim 2, wherein the determination of whether an urgent transmission of data is demanded by the second party further comprises:
determining whether an urgent receipt enable condition predetermined by the user is satisfied upon determining that the urgent receiving function is enabled, and
wherein, if the urgent receipt enable condition is satisfied, the phone number of the second party is stored.

4. The method according to claim 3, further comprising:
determining whether the user requires to set at least one among urgent phone number and the urgent receipt enable condition;
receiving at least one set by the user among the urgent phone number and the urgent receipt enable condition upon determining that the user requires to set at least one urgent phone number and the urgent receipt enable condition; and
storing at least one among the set urgent phone number and the set urgent receipt enable condition, and re-determining whether an urgent transmission of data is demanded by the second party during communication with the first party.

5. The method according to claim 3, further comprising:
determining whether the user requires update of at least one urgent phone number and the urgent receipt enable condition;
receiving at least one which the user sets to update among the urgent phone numbers and the urgent receipt enable condition upon determining that the user requires update of at least one among the urgent phone number and the urgent receipt enable condition; and
updating at least one among a previous urgent phone number and a previous urgent receipt enable condition into at least one among the set urgent phone number and the set urgent receipt enable condition, storing the update result, and re-determining whether an urgent transmission of data is demanded by the second party during communication with the first party.

6. The method according to claim 3, wherein the urgent receipt enable condition is a condition where the second party requires the urgent transmission of data while data is being transmitted to the first party.

7. The method according to claim 3, wherein the urgent receipt enable condition is a condition where the second party requires the urgent transmission of data while data is being received from the first party.

8. The method according to claim 3, wherein the urgent receipt enable condition is a condition where the second party requires the urgent transmission of data while data is being received or transmitted from or to the first party.

9. The method according to claim 6, wherein the data to be transmitted to the first party is prestored data.

10. The method according to claim 1, further comprising:
determining whether all of the data transmitted from the second party is received after the communication with the first party has been interrupted to receive the data from the second party; and
restarting communication with the first party upon determining that all data from the second party has been received.

11. The method according to claim 10, wherein the restarting communication with the first party upon determining that all data from the second party has been received comprises:
retransmission of the data to the first party; and
receiving data retransmitted from the first party.

12. The method according to claim 10, wherein the restarting communication with the first party upon determining that all data from the second party has been received comprises:
reading data stored when communication with the first party is interrupted; and
retransmitting the read data to the first party.

13. The method according to claim 1, wherein communication with the first party is a telephone call.

14. An apparatus to urgently receive data provided to a facsimile machine, the apparatus comprising:
a communication request detector to check whether during communication with a first party an urgent transmission of data is required from a second party previously determined to be capable of urgently receiving the data and to output the checked result as a first control signal; and
a data communication controller to interrupt communication with the first party in response to the first control signal and to receive the data from the second party.

15. The apparatus according to claim 14, wherein the communication request detector comprises:
a signal detector to detect an access request signal from the second party when communication with the first party is in progress, and to output the detected result as a second control signal;
an enable detector to check whether an urgent receiving function is enabled in response to the second control signal, and to output the checked result as a third control signal;
a first memory to store a phone number of the second party in response to the third control signal; and
a number comparator to check whether the phone number from the first memory is an urgent phone number predetermined by a user, and to output the checked result as the first control signal.

16. The apparatus according to claim 15, wherein the communication request detector further comprises:
a condition detector to check whether an urgent receipt enable condition predetermined by the user is satisfied in response to the third control signal, and to output the checked result as a fourth control signal, wherein the first memory stores the phone number of the second party in response to the fourth control signal.

17. The apparatus according to claim 15, further comprising:
a set request detector to check whether the user requires to set at least one urgent phone number and the urgent receipt enable condition, and to output the checked result as a fifth control signal; and
a phone number and condition setting unit to receive the at least one set urgent phone number and the urgent receipt enable condition in response to the fifth control signal, wherein the urgent receipt enable condition is predetermined by the user and the first memory stores at least one of the set urgent phone numbers and the set urgent receipt enable condition input from the phone number and condition setting unit.

18. The apparatus according to claim 15, further comprising:
an update request detector to check whether the user requires to update at least one urgent phone number and the urgent receipt enable condition, and to output the checked result as a sixth control signal; and
a phone number and condition setting unit to receive at least one updated among the urgent phone numbers and the urgent receipt enable condition in response to the sixth control signal, wherein the urgent receipt enable condition is predetermined by the user and the first memory updates a previous urgent phone number into the set urgent phone number and a previous urgent receipt enable condition into the set urgent receipt enable condition, and stores the update result.

19. The apparatus according to claim 17, wherein the phone number and condition setting unit comprises:
a key manipulator to allow manipulation by the user to generate at least one of the urgent telephone number and the urgent receipt enable condition, and to output at least one generated urgent telephone number and urgent receipt enable condition in response to the fifth or sixth control signal.

20. The apparatus according to claim 17, wherein the phone number and condition setting unit comprises:
a second memory to store a phone number list;
a display to read the phone number list from the second memory and to display the read phone number list to the user; and
a phone number selection unit to determine as an urgent phone number a phone number selected from the displayed phone number list by the user, and to output the determined urgent phone number in response to the fifth or sixth control signal.

21. The apparatus according to claim 16, wherein the condition detector checks whether the urgent receipt enable condition is satisfied in response to the third control signal, where the urgent receipt enable condition is a case where the second party demands an urgent transmission of data while data is being transmitted to and/or received from the first party.

22. The apparatus according to claim 21, wherein the data communication controller comprises, a third memory which stores the data being transmitted to the first party, in response to the first control signal.

23. The apparatus according to claim 14, further comprising:
a transmission completion detector to check whether the data communication controller has received all of the data transmitted from the second party, and to output the checked result as a seventh control signal; and
a communication restart unit to restart the communication with the first party in response to the seventh control signal.

24. The apparatus according to claim 25, wherein the communication restart unit comprises:
a data request unit to generate a data transmission request signal to require data retransmission to the first party in response to the seventh control signal; and
a data receiving unit to receive data retransmitted from the first party.

25. The apparatus according to claim 25, wherein the communication restart unit comprises a data transmission unit that reads data stored when communication with the first party is interrupted in response to the seventh control signal, and retransmits the read data to the first party.

26. The apparatus according to claim 14, wherein communication with the first party is a telephone call.

27. The method according to claim 1, wherein the determination of whether an urgent transmission of data is demanded by the predetermined second party is performed while data is received from and transmitted to the first party.

28. The method according to claim 1, wherein the determination of whether an urgent transmission of data is demanded by the second party further comprises:
determining whether data transmitted from the second party should be urgently received.

29. The apparatus according to claim 15, further comprising:
an enable button to allow a user in communication with the first party to enable the urgent receiving function in response to the second control signal, and to output the third control signal to indicate that the urgent receiving function is enabled.

30. The method according to claim 1, wherein the interruption occurs when a facsimile transmission of data is being established to the first party.

31. A method to urgently receive data via facsimile, comprising:
storing at least one phone number which a user determines to be urgent;
determining whether an access signal requiring urgent transmission of data via facsimile is requested;
comparing the at least one phone number stored with a phone number via which the access signal requesting transmission of data is requested; and
interrupting an on-going communication to receive the facsimile data requiring urgent transmission.

32. A method to urgently receive data via facsimile, comprising:
checking whether an urgent transmission of data is required from a second party during communication with a first party;
outputting the checked result as a first control signal; and
interrupting communication with the first party in response to the first control signal to receive the data from the second party.

33. The method according to claim 32, further comprising:
determining whether the phone number of the second party is a predetermined urgent phone number.
